(19) United States
(12) Patent Application Publication
(10) Pub. No.: US 2016/0037808 A1
(43) Pub. Date: Feb. 11, 2016

(54) ARTHROPOD PROTEIN-FORTIFIED ALIMENTARY FLOUR AND METHODS OF MANUFACTURE

(71) Applicant: Bitty Foods, LLC, San Francisco, CA (US)

(72) Inventor: Megan Renee Miller, San Francisco, CA (US)

(73) Assignee: Bitty Foods, LLC

(21) Appl. No.: 14/819,254

(22) Filed: Aug. 5, 2015

Related U.S. Application Data
(60) Provisional application No. 62/033,620, filed on Aug. 5, 2014.

(51) Int. Cl. A23L 1/10; A23L 1/305

(52) U.S. Cl. CPC A23L 1/1041; A23L 1/3058; A23V 2002/00

(57) ABSTRACT

Arthropod-fortified alimentary flour compositions are provided. The alimentary flour compositions functionally mimic the properties of traditional wheat-based flours as judged by at least one characteristic selected from nutrition, lightness, elasticity and shelf life without comprising wheat as a majority ingredient in the composition. The flour compositions provide a nutritional, grain-free, environmentally friendly substitute to grain-based flour foodstuffs that satisfy carbohydrate, protein, mineral, and vitamin requirements, without abandoning the capabilities provided by grain-based flour in cooking.

### REFERENCE TO RELATED APPLICATIONS

This application claims priority to U.S. Provisional Application No. 62/033,620, filed, Aug. 5, 2014, the disclosure of which is incorporated herein by reference.

### FIELD OF THE INVENTION

This disclosure is generally directed to protein-fortified, multifunctional alimentary flour compositions of use as substitutes for wheat-based flour and their method of production and fortification; and more particularly to grain-free flour compositions fortified by arthropod-derived proteins.

### BACKGROUND

First made by crushing and grinding wheat and other grains, the origin and history of flour stretches back thousands of years. Over time, these grain-based flours have become a staple in diets around the world. Alternative materials, such as acorns, rice, almonds and chickpeas have also been used to make flour and additional fortifying materials have been added to these flour products to increase their nutrient content.

Wheat and related grains are generally composed of complex carbohydrates with a relatively low protein concentration. The protein concentration in wheat is accounted for in large part by the protein gluten. Gluten provides elasticity to dough and affects its consistency for baking. Different concentrations of gluten affect the use of flour for baking. For instance, breads often require higher concentrations of gluten than do cakes, and, in turn, dough with higher protein content will make breads that are more chewy. By contrast, dough with lower protein content, such as that used for cookies and cakes, produces baked goods that crumble more easily.

Increasingly, consumers are desirous of high-protein, low-saturated fat, and low-carbohydrate diets. Many health benefits have been reported associated with such diets including lower cholesterol, the promotion of weight loss, and heart-disease prevention. In order to meet this consumer demand, many companies are fortifying and/or enriching foods and making supplements designed with these dietary goals in mind. For example, protein supplements derived from whey and soy are being used to provide high-protein food products that lack saturated fats.

### BRIEF SUMMARY OF THE INVENTION

Many embodiments are directed to multifunctional, arthropod protein-fortified alimentary flour compositions, and methods of their manufacture.

Some embodiments are directed to a fortified flour composition designated by the following compositional equation:

F_{100-w+x+y+z}+P_{w}+Bₓ+TD_{y}+TM_{z}

where:
F is at least one fiber/starch material selected from the group of cereal-grain-based, root-based, tuber-based, nut-based, powderized fruit or vegetable based fiber/starch materials;
P is at least one fortifying material selected from the group of powderized arthropods and/or arthropod-derived compounds, and w is a concentration of P by weight of the flour composition of from 10 to 50%;
B is at least one binding agent selected from the group of vegetable gums, finely ground seeds, psyllium husks, and combinations and mixtures thereof, and x is a concentration of B by weight of the flour composition of from 1 to 5%;
TD is at least one density improving textural supplement selected from the group of extracted starches, such as, tapioca, lentil, arrowroot, potato, corn, and mixtures thereof, and y is a concentration of TD by weight of the flour composition of from 0 to 20%;
TM is at least one moisture improving textural supplement selected from the group of ground nuts, such as, coconut, brazil and almond, and mixtures thereof, and z is a concentration of TM by weight of the flour composition of from 0 to 20%; and
wherein the concentration of F is at least 30% by weight of the flour composition.

In other embodiments the flour composition is grain-free.

In still other embodiments F is root-based. In some such embodiments F is cassava root.

In yet other embodiments P is powderized cricket.

In still yet other embodiments B is a xanthan gum, and x is a concentration of no greater than 2% by weight.

In still yet other embodiments y is from 5 to 15% by weight of the flour composition. In some such embodiments TD is tapioca starch.

In still yet other embodiments z is from 3 to 7% by weight of the flour composition. In some such embodiments TM is ground coconut.

In still yet other embodiments F is at least 50% by weight of the flour composition.

In still yet other embodiments P is powderized cricket, and w is at least 30% by weight of the flour composition.

In still yet other embodiments F is cassava root and comprises at least 50 by weight of the flour composition, P is powderized cricket and w is from 25 to 35% by weight of the flour composition, B is xanthan gum and x is from 1 to 2% by weight of the flour composition, TD is tapioca starch and y is from 5 to 15% by weight of the flour composition, and TM is ground coconut and z is from 3 to 7% by weight of the flour composition.

Some other embodiments are directed to a method of manufacturing an alimentary flour composition including:
providing at least one fiber/starch material selected from the group of cereal-grain-based, root-based, tuber-based, nut-based, powderized fruit or vegetable based fiber/starch materials;
providing at least one fortifying material selected from the group of powderized arthropods and/or arthropod-derived compounds, and w is a concentration of P by weight of the flour composition of from 10 to 50%;
providing at least one binding agent selected from the group of vegetable gums, finely ground seeds, psyllium husks, and combinations and mixtures thereof;
weighing the at least one fiber-starch material, the at least one fortifying material and the at least one binding agent such that the fiber starch material comprises at least 30% by weight of the flour composition, such that the at least one fortifying material comprises at least from 10 to 50% by weight of the flour composition, and such that the at least one binding agent comprises at least from 1 to 5% by weight of the flour composition;
mixing the weighed fiber-starch material, fortifying material and binding agent until the individual components are dispersed together into a flour composition; and
sifting the flour composition to remove any particles having a size greater than 0.5 mm.

In other embodiments the method further includes providing and weight at least one density improving textural supplement selected from the group of extracted starches, such as, tapioca, lentil, arrowroot, potato, corn, and mixtures thereof, such that the density improving textural supplement comprises from 5 to 15% by weight of the flour composition.

In still other embodiments the method further includes providing and weight at least one moisture improving textural supplement selected from the group of ground nuts, such as, coconut, brazil and almond, and mixtures thereof, such that the moisture improving textural supplement comprises from 3 to 7% by weight of the flour composition.

In yet other embodiments the method further includes pre-processing the fortifying material including:
dehydrating the fortifying material until a thermogravimetric moisture analysis reveals water content of the fortifying material measuring 5% or less; and
milling the dehydrating fortifying material into particles and sieving the particles to a particle size no greater than 0.500 mm.

In still yet other embodiments the fiber/starch material is cassava root, the fortifying material is powderized cricket, and the binding agent is xanthan gum. In some such embodiments the cricket is fed a nutrient-enhanced feed mixture prior to processing.

In still yet other embodiments the fortifying material is a protein isolate of cricket.

Additional embodiments and features are set forth in part in the description that follows, and will become apparent to those skilled in the art upon examination of the specification, or may be learned by the practice of the invention. A further understanding of the nature and advantages of the present invention may be realized by reference to the remaining portions of the specification and the drawings, which form a part of this disclosure.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1 provides a flow-chart of a method of manufacture of a multi-functional, arthropod protein-fortified alimentary flour in accordance with embodiments of the invention.

FIG. 2 provides a flow-chart of a method of manufacture of an arthropod-derived high-protein flour additive in accordance with embodiments of the invention.

### DETAILED DESCRIPTION

The present disclosure may be understood by reference to the following detailed description, taken in conjunction with the drawings as described below. It is noted, for purposes of illustrative clarity, certain elements in various drawings may not be drawn to scale.

In accordance with the provided disclosure and drawings, arthropod protein-fortified alimentary flour compositions are provided. In many embodiments, the alimentary flour compositions functionally mimic the properties of traditional wheat-based flours as judged by at least one characteristic selected from nutrition, lightness, elasticity and shelf life without comprising wheat as a majority ingredient in the composition. In many other embodiments the flour compositions provide a nutritional, grain-free, environmentally friendly substitute to grain-based flour foodstuffs that satisfy carbohydrate, protein, mineral, and vitamin requirements, without abandoning the capabilities provided by grain-based flour in cooking.

In many embodiments the alimentary flour compositions are comprised of at least a functional fiber and/or starch material and a fortifying material. In some embodiments, the alimentary flour compositions are formulated with functional fiber and starch materials that may include a starchy plant material or derivative, such as, for example, from roots and tubers, powderized fruits or vegetables, nuts, seeds and/or beans, and derivatives and/or mixtures thereof. In some embodiments the functional fiber and starch materials may include traditional cereals and/or pseudo-cereal grains, grasses or legumes. In some other embodiments, the fortifying materials may include protein materials derived from member of the phylum Arthropoda, such as, for example, insects. Such insect-derived fortifying proteins may include dried powders of insects, insect larvae, etc. In other embodiments the grain-less flour compositions may include supplemental additive materials to improve the taste and consistency of the compositions. In some such embodiments, the supplemental additive materials may include binding agents, starches, nut meals and preservatives.

### DEFINITIONS

In many embodiments in accordance with this disclosure, the following terms may take the meanings as set forth below:

The term “foodstuff” may refer to any substance that may be consumed by humans to satisfy nutritional requirements, including, for example, baking breads, pizza, pastries, muffins cakes, frying cakes, cereals, pastas, tortillas, crackers, chips, etc.

The term “fortified” may refer to a composition that included added sources of protein, vitamins, minerals, etc. In some embodiments the fortifying protein sources may be based on one or more dried and powderized arthropod sources, such as, for example, insects including crickets, etc. that provide a more complete protein source (e.g., number of amino acids provided) than the protein sources found in traditional grain-based flours.

The term “flour” or “multifunctional flour” may refer to an amalgam of ingredients at specific proportions that can serve as a cup-for-cup replacement for conventional wheat or other grain-based flours. In some embodiments the flour or multifunctional flours may be used to create foodstuff products by establishing in the finished products a uniform and tender crumb, proper structure, and optimal retention of air (loft) similar to those obtained using wheat or other grain-based flours. Although in some embodiments the flours described may be intended for use in baking, one skilled in the art will recognize that the flour can be used for non-baking recipes, such as, frying or other applications, such as, by direct consumption or as an ingredient of a foodstuff.

The term “arthropod” refers to an organism that is classified as a member of the phylum Arthropod. The term refers not only to the mature organism, but also to the larval or nascent form of the organism that may eventually grow into the mature organism. Exemplary arthropod protein sources may include, for example, insects, such as crickets.

The term “grain-less”, “grain-free”, or “gluten-free” may refer to and be consistent with relevant nutritional and/or regulatory requirements, including products where any unavoidable presence of gluten in the foodstuff bearing the claim in its labeling is below 20 ppm gluten.

The phrase “consistency of grain-based flour” may refer to the ability of the flour to mimic the taste, volume, texture, and loft typically observed when using wheat or other grain-based flour in recipes.

The term “thickener” refers to a substance, such as a binding agent, added to a mixture in order to make it firmer or thicker including polysaccharides, such as, for example, starches, vegetable gums, and pectin, or proteins. Examples suitable for use as thickeners include, for example, starches, such as, arrowroot, cornstarch, katakuri starch, potato starch, sago, tapioca and their starch derivatives; vegetable gums, such as, alginin, guar gum, locust bean gum, and xanthan gum; proteins, such as, collagen, egg whites, furcellaran, and gelatin, and sugars, such as, agar and carrageenan.

The term “mill” or “milling” refers to the grinding, crushing, or cutting of a material.

The term “nutritionally optimized” refers to a flour composition that is formulated for a specific consumer group's nutritional needs by either addition, subtraction, or substitution with ingredients or chemicals.

The term “farming” refers to raising and harvesting arthropods from larval to mature form.

The term “nutrients” may refer to vitamins, minerals, fats, proteins individually or in any combination.

The term “harvesting” refers to the collection and killing of the arthropods.

All concentration listed in the disclosure are by weight unless otherwise indicated.

### Embodiments of Alimentary Flour Compositions

Traditional baking flours are typically derived from cereal or pseudo-cereal grains, composed of an admixture of starches, dietary fibers and trace amounts of micronutrients and proteins. These grains or seeds are typically members of the monocot family Poaceae, and many contain protein composites called glutens, which can be highly functional in creating desirable structure and mouth-feel in baked goods, but which have been implicated in gastro-intestinal sensitivities and systemic allergies in certain populations of people characterized as “gluten-intolerant” or “gluten-sensitive.” Traditional grain-based flours may also contain carbohydrate-binding proteins called lectins and infermentable, poorly absorbed short chain carbohydrates (FODMAPs), which have been implicated in intestinal irritation and distress in some populations of people, and are as a result avoided by adherents to grain-free nutrition plans, including the Paleo, Primal, and Bulletproof diets. (See, e.g., Biesiekierski, J R et al., Gastroenterology, 145(2):320-8, 2013)

It is estimated that 2,000,000 Americans are unable to eat grain-based products. As a result, this segment of the population must rely on a grain-free diet. Moreover, because of the growing health concerns that surround the use of gluten-containing grains as a source of carbohydrates, increasingly, consumers who do not suffer from the effects of gluten consumption are also altering their diets to gluten-free, high-protein diets. Accordingly, a need also exists to diversify carbohydrate staple crops by providing non-grain alternatives to satisfy daily nutrient requirements. In many countries, roots and tubers are used in place of grains due to their ability to grow well on poor soils with little rainfall. These roots and tubers, such as the cassava plant, offer a staple crop and alternative to wheat. For instance, the cassava plant can be used in baking products such as bread. Roots and tubers, such as the cassava plant, are also low in gluten. Although previous attempts have been made to create grain-free flours, such as a cassava-based formulation, these grain-less flour materials still result in a carbohydrate-rich product. (See, e.g., U.S. Pat. Pub. No. 2012/0070559) Moreover, most of these substitute starches, including the cassava root, lack the protein source gluten and are therefore low in protein content when compared with conventional whole-grain wheat-based flour materials.

In the developing world protein deficiency is an endemic nutritional malady. What is more, the resource-intense nature of current protein production (e.g., animal production) is putting growing financial and environmental demands on both developing and developed countries. In particular, the expense associated with raising livestock, either for meat use or for the production of diary products such as whey, and farming plants such as soy, hinders the ability of many people to obtain proper nutrition. Among the problems associated with current methods of cultivating various forms of protein include the need for a large tracts of land and an abundance of desalinated water. Accordingly, a need exists to obtain high quality protein sources that can be produced with reduced resource (e.g., landmass and water) consumption.

It has now been recognized that insects may provide a source of protein that is both higher in quality, and lower in resource and environmental demands. Insects have been identified as a particularly promising source of protein. There are several advantages to farming arthropods for protein. The first is that there are some 2,000 edible insect species that can be harvested, providing a diversified human food stock. Second, little care or effort is required to raise arthropods when compared to livestock such as cattle, sheep, and chicken. Third, unlike most livestock, viruses and diseases that affect arthropods are generally not transferable to humans. Fourth, harvesting and processing the organisms is a relatively simple process. Fifth, arthropods mature significantly faster than conventional livestock, and, moreover, arthropods can be harvested at any lifecycle growth stage desired. Interestingly, during their maturation process, arthropods can be nutritionally enriched with vitamins and minerals providing advantages over whey production. Sixth, insects contain an ideal ratio of nutrients including protein, healthy fats, fiber, amino acids, vitamins and minerals. (See, e.g., MD Finke, Zoo Biol. 2013 January-February; 32(1):27-36.) Finally, the land and water requirements are considerably less than conventional plants such as soy and livestock. For example, 1 pound of crickets requires 1 gallon of water for growth, whereas one pound of beef requires 2500 gallons. Thus, in totality farming arthropods are far more environmentally friendly than raising conventional livestock or growing plants such as soy to provide protein.

These advantages have led some food producers to include arthropod protein, including insect protein as a supplement in some foodstuffs. However, although attempts have been made to address the processes necessary for rearing arthropods, and processing arthropods into a powdered nutritional supplement, these processes do not address the need for a multi-functional flour substitute that can be used as the basis of a wide variety of staple food products. (See, e.g., WO 2014/046529 A2 and US. Pat. Pub. No. 2012/0148712.) Indeed, thus far there has been no attempt to include such alternative protein sources in grain-free compositions capable of mimicking the properties of grain-based flour. In particular, while several grain-free flours are currently on the market, these flours typically have low protein concentrations. One reason for this lack of fortified grain-free flour is that flour, as a composition, has properties that are complicated to reproduce. Moreover, the use of flour in baking is itself a complicated process where the individual ingredients of the flour and foodstuff interact through mixing, baking, volume expansion, etc. to form the final product and therefore must be in balanced with each other. For example, the type and amount of an added fiber has been shown to impact the stability of dough. (See, e.g., Wang et al., Food Chemistry, 79(2):221-6, 2002.) In addition, bread requires a peculiar interaction of gluten and the starches to create elasticity within the dough.

Elasticity in the context of flour is a sensory perception that is felt when dough is stretched and released. The elasticity of dough is generally considered “good” when the dough contracts or “recovers” rapidly to approximately its original shape. Because of the inherently subjective nature of elasticity it can be a difficult quality to quantify. However, as previously discussed the elasticity of dough gives rise to certain baking properties and qualities that can be very carefully determined using standardized baking from volume tests, which are accepted internationally as an objective and correlative measurement of the quality of wheat-based flours and their elasticity properties. Examples of suitable standardized baked from tests may include, for example, any one of the American Association of Cereal Chemists (AACC) “Baking Quality” methods selected from: 10-11.01, 10-12.01, 10-15.01, 10-31.03, 10-50.05, 10-52.02, 10-53.01, 10-54.01, 10-80.01, 10-90.01, and/or International Association for Cereal Science and Technology (ICC) “Method for Test Baking of Wheat Flours” No. 131, among others.

This elasticity, in turn, aids in trapping gasses to make the dough rise and contributes to the loft/lightness of the bread. Lacking gluten, grain-free flours are at a disadvantage because the flour compositions lack the characteristic properties of grain-based flours. Accordingly, used as a standalone ingredient, dried, powdered insects lack the functional properties of a baking flour, providing no qualities of binding or air retention necessary for the creation of structure, loft and texture in finished baked goods and related staple foods.

Thus, in many embodiments multi-functional alimentary flour compositions that are not only enriched with arthropod (e.g., insect) protein, but also formulated with the correct ratio of functional ingredients to ensure optimal performance across a broad variety of baked good and food product applications are provided. In many embodiments, alimentary flour compositions having high arthropod (e.g., insect) protein concentrations are provided. In some embodiments the alimentary flour compositions provide high protein concentrations while mimicking the elasticity and loft of grain-based flour. Embodiments of the alimentary flour may be formulated as grain-less, e.g., without grain-derived ingredients and thus may not contain glutens, lectins or FODMAPs. Therefore, grain-less flour compositions in accordance with embodiments may be appropriate for populations of gluten-intolerant and gluten-sensitive people, as well as for adherents to grain-free nutrition plans, while delivering the added benefits of increased protein and micronutrient content.

Turning to the constituents of the compositions, in many embodiments the multifunctional, nutritionally enhanced alimentary flour compositions at least comprise a fiber/starch material, an arthropod (e.g., insect) based protein fortifying material, and a binding agent, each of these materials being disposed in the composition in proportions such that the flour compositions have elasticity and elasticity recovery properties sufficient to yield a baked volume measured at a defined form ratio (height/width) in accordance with a suitable standardized methodology substantially similar to that found for wheat-based flour. In many embodiments the baked volume of the alimentary flour is within 25% of the baked volume for wheat-based flour, in other embodiments within 15%, in still other embodiments within 10%, and in still other embodiment within 5%.

In some embodiments of multi-functional alimentary flour compositions, the fiber/starch material may comprise one or more functional starches of: cereal-grain-based, tuber-based, nut-based, powderized fruit or vegetable based fiber/starch materials. Exemplary fiber/starch materials in accordance with embodiments include functional starches, fibers or other derivatives of one or a mixture of roots or tubers, such as, for example, of a cassava plant, etc.; pulverized starchy nuts or seeds, such as, for example, acorns, lentils, peas, etc.; one or a mixture of a powderized starchy fruit or vegetable, such as, for example, banana, plantain, jackfruit, etc.; and/or one or more traditional cereals or pseudocereal grains, grasses or legumes, including but not limited to barley, buckwheat, oats, corn, rice, sorghum, garbanzo, fava, teff, amaranth, quinoa, etc. Although a single source or type of fiber/starch material may be used, it should be understood that combinations and mixtures of two or more fiber/starch materials may be incorporated into embodiments of the alimentary flour compositions.

The fiber/starch material is incorporated into the flour compositions at a concentration sufficient to provide the final flour compositions with sufficient elasticity to serve as a cup-for-cup replacement for traditional wheat-based flour. In many embodiments the fiber/starch material is included in a concentration of at least 30% (by weight). In some embodiments the concentration of the fiber/starch material is at least 30%, but no greater than 95%. In still other embodiments the concentration of fiber/starch material is at least 30%, but no greater than 80%. In yet other embodiments the concentration of the fiber/starch material is at least 50%, but no greater than 75%.

In many embodiments the arthropod (e.g., insect) based protein fortifying material comprises powderized arthropods and/or arthropod-derived compounds, such as, members of the phylum arthropoda, arthropod-based protein isolate or other arthropod-based nutritional derivatives capable of providing more complete proteins (e.g., number of amino acids contained) than is found in traditional wheat-based flour. Although many exemplary embodiments discuss the use of cricket protein, the phylum Arthropoda refers to a group of organisms that includes many types of insects, for example, bees, hornets, crickets, etc. In some embodiments, the arthropod protein is formed from field crickets of the genera Acheta and Gryllus (e.g., Acheta domesticus, Gryllus assimilus, etc.). Although single sources of proteins are described, it should be understood that mixtures and/or derivatives of these protein sources may be utilized. Moreover, additional macronutrients or other protein, vitamin and/or mineral supplement materials may be included in the compositions.

Although the arthropod-based protein fortifying material may be formed from arthropod feedstock prepared via a variety of methods, including, boiled, steamed, fried or roasted, in many embodiments, dried, powdered arthropod and arthropod-based nutrient derivatives are provided having a water content of no greater than 5%, and in some embodiments no greater than 3%.

The fortifying material is incorporated into the flour compositions in accordance with many embodiments at a concentration sufficient to provide at least the same amount of protein as is found in conventional wheat-based flour. In many such embodiments, the fortifying material comprises at least 10%, but no greater than 50% of the flour composition. As the fortifying materials are very fibrous, at greater than 50% of the flour composition the composition loses the ability to bind together. By contrast, a concentration of at least 10% fortifying material ensures at least 11 g of protein in one cup of the flour composition, which matches the level of protein found in traditional wheat-based flour compositions. In some embodiments the concentration of fortifying material is between 20 and 50% of the flour composition by weight. In still other embodiments the fortifying material is between 25 and 35% of the flour composition by weight.

In many embodiments the binding agent may be selected from one of a number of materials capable of substituting for the binding activity of gluten in conventional wheat-based flour. In many embodiments suitable binding agents may include vegetable gums, such as, for example, xanthan gum or guar gum; finely ground seeds, such as, for example, chia or flax seeds; psyllium husks; and combinations and mixtures thereof. Although specific binding agents have been proposed it will be understood that many substances are used in gluten-free cooking (e.g., soy powder, rice, agar agar, gelatin, nut and seed butters, arrowroot, tapioca, starches such as corn or potato, purées such as pumpkin, sweet potato, yam, banana, plantain, dates, figs, zucchini, carrot, dried coconut, beans and apples, honey, flours such as teff, buckwheat, amaranth, chickpea, sorghum, almond, and sweet rice, etc.) and these alternatives, where suitable for use in flour compositions, are also contemplated in accordance with embodiments.

The binding materials are included because of the fibrous nature of the fortifying materials, which, if not compensated for would yield a flour composition without the elasticity and binding of conventional wheat-based flours. In particular, in traditional wheat-based flours gluten acts as a binder, “gluing” the plant fibers together in a mesh that holds air and gives the dough fluffiness and loft. Accordingly, the binding material is incorporated into the flour compositions in accordance with many embodiments at a concentration sufficient to yield a fortified flour composition having the same elasticity as conventional wheat-based flour. In many embodiments the binding agent has a concentration of from 1 to 5%, and in other embodiments from 2 to 3% of the flour composition. Some embodiments incorporate a vegetable gum at a concentration of no more than 3% of the flour composition.

Many embodiments may also include one or more supplemental materials including, for example, additional texture and/or taste agents. Some embodiments incorporate texture agents that improve the density or lightness of the flour compositions during baking. Exemplary density textural agents include, for example, extracted starches, such as, tapioca, lentil, arrowroot, potato, corn, etc., among others and mixtures thereof. Some embodiments may alternatively or additionally incorporate texture agents that improve the moisture retention of the flour compositions during baking. Exemplary moisture textural agents include, for example, nut meals, such as, coconut, almond, brazil, etc., among others and mixtures thereof. In many embodiments these density and/or moisture textural agents may each comprise from 5 to 20% of the flour composition. In some embodiments the density textural agent comprises between 7 and 15% of the flour composition. In other embodiments the moisture textural agent comprises between 2 and 7% of the flour composition. These supplemental materials may be added in exchange for one or both of the fiber/starch material and/or the fortifying material.

In addition, preservatives and flour treatment agents (e.g., bleaching agents, oxidizing agents, reducing agents, and/or enzymes) may also be added in trace concentrations as necessary to improve the flour composition's baking capabilities, shelf-life and/or appearance. Exemplary flour treatment agents include, for example, bleaching or oxidizing agents, such as, carbamides, azodicarbonamides, bromates, phosphates, malted barleys, and iodates, among others; reducing agents, such as, L-cysteine, fumaric acids, bisulfates, yeasts and ascorbic acid, among other; and enzymes, such as, anylases, proteases and lipoxygenases, among others.

Many embodiments of fortified alimentary flour compositions may be designated by the following compositional equation:

F_{100-w+x+y+z}+P_{w}+Bₓ+TD_{y}+TM_{z}

where:
F is a fiber/starch material selected from the group consisting of: cereal-grain-based, tuber-based, nut-based, powderized fruit or vegetable based fiber/starch materials;
P is a fortifying material selected from the group of: powderized arthropods and/or arthropod-derived compounds, and w is a concentration of P by weight of the flour composition of from 10 to 50%;
B is a binding agent selected from the group of vegetable gums, finely ground seeds, psyllium husks, and combinations and mixtures thereof, and x is a concentration of B by weight of the flour composition of from 1 to 5%;
TD is a density improving textural supplement selected from the group of extracted starches, such as, tapioca, lentil, arrowroot, potato, corn, and mixtures thereof, and y is a concentration of TD by weight of the flour composition of from 0 to 20%;
TM is a moisture improving textural supplement selected from the group of ground nuts, such as, coconut, brazil and almond, and mixtures thereof, and z is a concentration of TM by weight of the flour composition of from 0 to 20%; and
wherein the concentration of F is at least 30% by weight of the flour composition.

In many other embodiments the alimentary flour is formulated without grain-derived ingredients and thus may not contain glutens, lectins or FODMAPs. In such embodiments F would therefore contain no cereal or grain-based sources of fiber and starch. In such embodiments, therefore, the alimentary flour described may be appropriate for populations of gluten-intolerant and gluten-sensitive people, as well as for adherents to grain-free nutrition plans, while delivering the added benefits of increased protein and micronutrient content.

In other embodiments, the content of F, B, TD and TM in the flour compositions is sufficient such that the baked volume of the alimentary flour is within 25% of the baked volume for wheat-based flour in accordance with standard quantitative baking tests as would be known to those skilled in the art. In other embodiments the baked volume would be within 15%, in still other embodiments within 10%, and in still other embodiment within 5%.

In still other embodiments, the content of P in the flour compositions is sufficient such that the protein content of the flour compositions is at least as high as that found in conventional wheat-based flour. In many other embodiments the content of P in the flour compositions is such that the protein content of the flour compositions is at least twice as great as that found in conventional wheat-based flour. In some such embodiments the concentration of P in the flour compositions is at least 20%.

### Embodiments of Methods of Manufacturing Alimentary Flour Compositions

Although the above description provides embodiments of alimentary flour compositions incorporating fiber/starch, fortifying and binding components blended in a formulation with other functional ingredients to produce an alimentary baking flour that is both versatile across baking applications and optimally nutritious for human health, it should be understood that embodiments are also directed to methods of manufacture of the alimentary flour compositions.

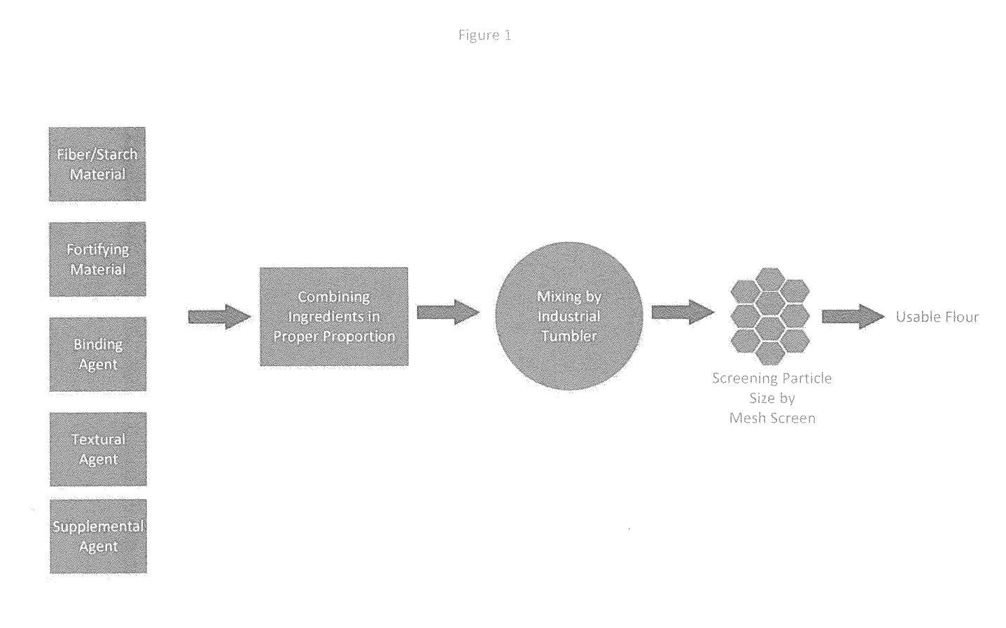

First, FIG. 1 provides a flow-chart, in accordance with many embodiments, that provides a method for formulating the flour compositions. As shown, in embodiments the fiber/starch material, the binding agent and the fortifying material, along with any textural agents or other supplemental flour treatment agents are weighed and mixed in proper proportions using an industrial tumbler until the individual ingredient particles are completely dispersed. The dispersed flour composition is then sifted through a mesh to remove any particles larger than 0.5 mm in size.

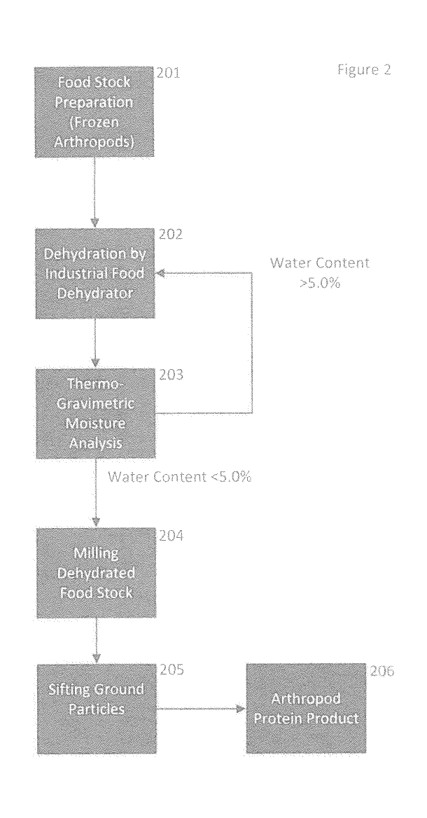

As shown in the flow-chart in FIG. 2, in many embodiments, prior to incorporation, the arthropod-based fortifying material is made by the following method:
Frozen whole arthropods (e.g., crickets) are spread in a single layer on perforated stainless steel sheets covered with silicone mesh.
The sheets are placed in an industrial food dehydrator at 180 degrees for approximately 2 to 7 hours, or until thermogravimetric moisture analysis reveals water content of cricket solids measuring 5% or less.
The whole, dried arthropods are then milled in an industrial burr grinder-mill and sieved to a particle size no greater than 0.500 mm, excluding larger particles and fibers that do not meet the size criteria.
The resulting whole cricket powder, containing an average of 70 grams of protein per cup and 18 grams dietary fiber, is then blended with other ingredients, as described above, to produce a protein-enriched flour that functions as an ingredient in a variety of baked recipes and food applications.

In alternative embodiments, the protein from the dried arthropods may be separated from the fat and fiber materials of the while arthropod before turning them into a powder. In such embodiments a protein extraction technique, such as, for example, cell disruption, mechanical or ultrasonic homogenization, temperature treatments, osmotic or chemical lysis, protein solubilization via organic or aqueous solvents or solutions, centrifugation, among others as may be known to those skilled in the art may be used to separate out the protein content. This protein isolate is then powderized and blended into the remainder of the flour composition. Such additional processing results in a higher protein, lower fat, flour with less fiber.

In other embodiments the nutritional advantages and flavor of edible arthropods may be enhanced by altering those arthopods' diets prior to harvesting. Insects and other arthropods intended for human consumption can be administered a nutrient-enhanced feed mixture formulated to deliver additional protein, vitamins, minerals or healthy fats that may be incorporated into the tissue of the animals prior to harvesting, and/or delivered through a loaded gut. They may also be fed aromatic food compounds such as herbs, spices, fruits or other natural feed sources, in order to create a finished human food product of exceptional quality and flavor. This patent describes novel, alimentary baking flour that may be nutritionally or organoleptically enhanced through methods of delivering such nutrients and flavors to the arthropods via their feed or water supply prior to harvesting and processing.

### Exemplary Embodiments

The person skilled in the art will recognize that additional embodiments according to the invention are contemplated as being within the scope of the foregoing generic disclosure, and no disclaimer is in any way intended by the foregoing, non-limiting examples

Table 1 provides a summary of an exemplary embodiment of a fortified alimentary flour composition formulated in accordance with the disclosure.

TABLE 1
Alimentary Flour Composition

| | | Compositional Range |
|---|---|---|
| Material Class | Ingredient | (% by weight) |
| Fiber/Starch | Cassava Root Powder | 50 to 55 |
| Fortifying Material | Dried Cricket Powder | 25 to 35 |
| Binding Agent | Xanthan Gum | 1 to 2 |
| Density Textural | Tapioca Starch | 5 to 15 |
| Material | | |
| Moisture Textural | Coconut Powder | 3 to 7 |
| Material | | |

This exemplary flour composition was tested by incorporating it into a number of conventional foodstuffs including: cookies, cakes, nutritional bars, breads, crackers and chips. In each case the flour produced a final foodstuff product comparable in volume, weight, moisture content, texture, and taste to those formed with conventional wheat-based flours. These results demonstrate that the alimentary flours made in accordance with embodiments are able to provide a cup-for-cup replacement for wheat-based flours while providing enhanced protein content (˜28 g/cup as compared to ˜11 g/cup for whole wheat flour) and being gluten-free.

Typically, nutritionally enhanced foods, including “nutraceuticals,” dietary supplements and foods that deliver added vitamins, minerals and protein, may be marketed specifically for athletes, populations of people with nutritional deficiencies, or those suffering from or recovering from illnesses. Embodiments herein describe a novel, multipurpose alimentary flour fortified with arthropod protein that can be used to create a new class of staple foods meant for daily consumption by people with diverse nutritional needs. As the alimentary flour in accordance with embodiments is a cup-for-cup replacement for conventional wheat-based flour, rather than being marketed as nutraceuticals or supplements, these foods can appear in grocery and retail stores as a more nutritious alternative to typical grain-based staples including cereals, breads, and pastas.

Moreover, the procedures and formulations described herein may be optimized for the production of specific food products. The procedures and formulations described herein may also be optimized for the needs of consumers with specific dietary requirements. For example, variations of the multifunctional alimentary flour may be nutritionally optimized for populations with gluten intolerance, celiac disease, vitamin or mineral deficiencies, protein deficiencies, or for people with specific dietary needs, like those with diabetes, heart-disease, autism, ulcerative colitis, Crohn's disease and other inflammation-related ailments.

### Doctrine of Equivalents

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

Reference throughout this specification to “one embodiment,” “one variation,” “an embodiment,” “a variation” or similar language means that a particular feature, structure, or characteristic described in connection with the embodiment or variation is included in at least one embodiment or variation of the present invention. Thus, appearances of the phrases “in one embodiment,” “in on variation,” “in an embodiment,” and similar language throughout this specification may, but do not necessarily, all refer to the same embodiment or variation.

What is claimed:

1. A fortified flour composition comprising:
F_{100-w+x+y+z}+P_{w}+Bₓ+TD_{y}+TM_{z}
where:
F is at least one fiber/starch material selected from the group of cereal-grain-based, root-based, tuber-based, nut-based, powderized fruit or vegetable based fiber/starch materials;
P is at least one fortifying material selected from the group of powderized arthropods and/or arthropod-derived compounds, and w is a concentration of P by weight of the flour composition of from 10 to 50%;
B is at least one binding agent selected from the group of vegetable gums, finely ground seeds, psyllium husks, and combinations and mixtures thereof, and x is a concentration of B by weight of the flour composition of from 1 to 5%;
TD is at least one density improving textural supplement selected from the group of extracted starches, such as, tapioca, lentil, arrowroot, potato, corn, and mixtures thereof, and y is a concentration of TD by weight of the flour composition of from 0 to 20%;
TM is at least one moisture improving textural supplement selected from the group of ground nuts, such as, coconut, brazil and almond, and mixtures thereof, and z is a concentration of TM by weight of the flour composition of from 0 to 20%; and
wherein the concentration of F is at least 30% by weight of the flour composition.

2. The flour composition of claim 1, wherein the flour composition is grain-free.

3. The flour composition of claim 1, wherein F is root-based.

4. The flour composition of claim 3, wherein F is cassava root.

5. The flour composition of claim 1, wherein P is powderized cricket.

6. The flour composition of claim 1, wherein B is a xanthan gum, and x is a concentration of no greater than 2% by weight.

7. The flour composition of claim 1, wherein y is from 5 to 15% by weight of the flour composition.

8. The flour composition of claim 7, wherein TD is tapioca starch.

9. The flour composition of claim 1, wherein z is from 3 to 7% by weight of the flour composition.

10. The flour composition of claim 9, wherein TM is ground coconut.

11. The flour composition of claim 1, wherein F is at least 50% by weight of the flour composition.

12. The flour composition of claim 1, wherein P is powderized cricket, and w is at least 30% by weight of the flour composition.

13. The flour composition of claim 1, wherein F is cassava root and comprises at least 50 by weight of the flour composition, P is powderized cricket and w is from 25 to 35% by weight of the flour composition, B is xanthan gum and x is from 1 to 2% by weight of the flour composition, TD is tapioca starch and y is from 5 to 15% by weight of the flour composition, and TM is ground coconut and z is from 3 to 7% by weight of the flour composition.

14. A method of manufacturing an alimentary flour composition comprising:
providing at least one fiber/starch material selected from the group of cereal-grain-based, root-based, tuber-based, nut-based, powderized fruit or vegetable based fiber/starch materials;
providing at least one fortifying material selected from the group of powderized arthropods and/or arthropod-derived compounds, and w is a concentration of P by weight of the flour composition of from 10 to 50%;
providing at least one binding agent selected from the group of vegetable gums, finely ground seeds, psyllium husks, and combinations and mixtures thereof;
weighing the at least one fiber-starch material, the at least one fortifying material and the at least one binding agent such that the fiber starch material comprises at least 30% by weight of the flour composition, such that the at least one fortifying material comprises at least from 10 to 50% by weight of the flour composition, and such that the at least one binding agent comprises at least from 1 to 5% by weight of the flour composition;
mixing the weighed fiber-starch material, fortifying material and binding agent until the individual components are dispersed together into a flour composition; and
sifting the flour composition to remove any particles having a size greater than 0.5 mm.

15. The method of claim 14, further comprising providing and weight at least one density improving textural supplement selected from the group of extracted starches, such as, tapioca, lentil, arrowroot, potato, corn, and mixtures thereof, such that the density improving textural supplement comprises from 5 to 15% by weight of the flour composition.

16. The method of claim 14, further comprising providing and weight at least one moisture improving textural supplement selected from the group of ground nuts, such as, coconut, brazil and almond, and mixtures thereof, such that the moisture improving textural supplement comprises from 3 to 7% by weight of the flour composition.

17. The method of claim 14, further comprising pre-processing the fortifying material comprising:
dehydrating the fortifying material until a thermogravimetric moisture analysis reveals water content of the fortifying material measuring 5% or less; and
milling the dehydrating fortifying material into particles and sieving the particles to a particle size no greater than 0.500 mm.

18. The method of claim 14 wherein the fiber/starch material is cassava root, the fortifying material is powderized cricket, and the binding agent is xanthan gum.

19. The method of claim 18, wherein the cricket is fed a nutrient-enhanced feed mixture prior to processing.

20. The method of claim 14, wherein the fortifying material is a protein isolate of cricket.
